(19) United States
(12) Patent Application Publication
(10) Pub. No.: US 2012/0053877 A1
(43) Pub. Date: Mar. 1, 2012

(54) METHOD FOR DETECTING ATYPICAL ELECTRONIC COMPONENTS

(75) Inventors: Francois Bergeret, Montberon (FR); Anne Ruiz, Toulouse (FR); Carole Soual, Toulouse (FR); Henri Caussinus, Pompertuzat (FR)

(73) Assignee: SARL IPPON, Montberon (FR)

(21) Appl. No.: 13/146,924

(22) PCT Filed: Feb. 2, 2010
(86) PCT No.: PCT/EP2010/051235

§ 371 Date: Oct. 20, 2011

(30) Foreign Application Priority Data
Feb. 2, 2009 (FR) 0900424

(51) Int. Cl. G06F 19/00

(52) U.S. Cl. 702/84

(57) ABSTRACT

A method for detecting atypical electronic components for the quality control of a set of n electronic components at the end of the manufacturing process, the components being subject to a number p of unit tests providing digital data, this set of n components consisting of electronic components whose response to each of the p unit tests is contained within pre-defined limits specific to each of the p tests, uses the multidimensional information of the p dimension responses of these n electronic components. The method uses a generalized principal component analysis for detecting atypical items in the semiconductor field, or in fields including modules assembled using electronic components (e.g. an ABS module, a smart card, etc.). The aim of the method is to get close to “zero defect”, in which no parts are detected as non-compliant by the client.

The present invention relates to the field of the quality control of parts and electronic components in particular.

### BACKGROUND OF THE INVENTION AND PROBLEM STATEMENT

The semiconductor industry produces integrated circuits, called electronic components, which are manufactured on groups of silicon wafers; each wafer comprises several hundred components.

To guarantee the working of these electronic components a first series of tests, called probe tests, is performed on each of the components while they are still part of a wafer.

Each of these tests, which respectively consist of an electronic measurement, is associated with a specification limit determined, amongst others, with the client for whom the electronic components are destined.

Electronic components for which the response to at least one test does not comply with the specifications for this test of this first test series (probe), are therefore considered defective and are rejected when they are separated from the wafer.

In contrast, electronic components whose responses comply for all the tests are assembled in a casing and then tested again by a second series of tests.

As for the first series of tests, specification limits are determined with the client for whom the electronic components are destined, and electronic components for which at least one response to a test does not comply with the specifications for that test in this second test series are rejected. This second series of tests can be duplicated at several temperatures (−40° C., +90° C. for example).

Thus, with this commonly used method, a component is rejected and therefore not delivered to the customer if at least one response to a test (in the first or second series of tests) is outside the specification limits associated with this test.

However, parts that have been delivered, and therefore have passed all the tests successfully, can have a latent defect that will be revealed when the part is utilized as part of the client's application, on delivery or later in the final application (an ABS brake for example).

This quality control, as currently usually practiced, thus appears insufficient and some supplemental methods have already been implemented, for instance in components designed for the automotive industry, to minimize these quality problems experienced by the client.

These supplemental methods are performed on the electronic components, usually after the first series of tests and/or after the second series of tests, and use the distributions of results for each of these tests to eliminate atypical electronic components, called outliers. They are thus used test by test for each test or for part of the two series of tests.

For example, a method called Part Average Testing (PAT) compares an electronic component's response for a test to the mean distribution of other electronic components' responses for this test; an electronic component is considered atypical if it gives a response for a test that is too far from the distribution of other electronic components' responses for this test. Similarly, a method called Geographic Part Average Testing considers an electronic component to be atypical which during the test, for example on a silicon wafer, is surrounded by non-compliant components. There is therefore a tendency to consider that the component surrounded by defective components is probably defective through “geographical” proximity.

Another supplemental method consists of creating mathematical regression models, i.e. of the correlation between components' results for various tests, and to consider as atypical, and therefore potentially defective, electronic components for which the correlation between two tests does not conform to the mean obtained for the other electronic components.

However, these supplemental methods, while constituting improvements relative to previous test methods, still have drawbacks. Typically, they still allow electronic components having a latent defect to be considered reliable and deliverable to the client.

This disadvantage is a problem, firstly because it forces the manufacturer to send the customer a new batch of replacement parts and reduces the client's perception of its quality level, and even more so because some of these components, although with a low unit cost, are critical components in the working of a more complex system, such as a motor controller or an ABS braking system. In this case, a component failure can lead to a serious accident whose consequences go far beyond the mere financial value of the component.

This risk leads manufacturers to choose to reject too many components, including many good components, because they use the univariate (PAT, etc.) or bivariate (regression, etc.) methods over a very large number of tests, which deprives them of a few percent of their production, while still not guaranteeing to eliminate all the potentially defective components.

Although these methods already have a certain level of performance, they are therefore insufficient to achieve zero defects.

### OBJECTIVES OF THE INVENTION

The objective of this invention is therefore to propose a method making it possible to refine the detection of atypical (and therefore potentially defective) electronic components in a set of electronic components subjected to a large number of tests so as to get close to zero defect, in accordance with the requirements of, for example, the automotive industry.

According to a second objective of this invention, this does not require the development of new tests on electronic components already tested by conventional methods.

A third purpose of the invention is to bring into the category of components conforming to the specifications, and thus salable, components that would have been removed in error (false negative) by the previous methods.

According to a fourth purpose of the invention, in some cases it can allow manufacturers of electronic components to eliminate costly reliability tests, known as “burn-in”, as parts rejected during this burn-in are picked up by our invention.

### DESCRIPTION OF THE INVENTION

To this end, the invention envisages a method for detecting atypical electronic components for the quality control of a set of n electronic components at the end of the manufacturing process, said components being subject to a number p of unit tests providing digital data, this set of n components consisting of electronic components whose response to each of the p unit tests is contained within pre-defined limits, called customer specification limits, and specific to each of the p tests, using the multidimensional information of these n electronic components' responses of dimension p.

It is understood that unlike the state of the art, which works in one or two dimensions, this method will work in p dimensions and thus will be able to use all the information from the p tests, and consequently identify more atypical components or call into question some rejected components.

Indeed, for the majority of atypical components, their latent defect is detectable in the atypia of these electronic components, if all the responses to the tests over all the electronic components to be tested are considered.

According to a preferred embodiment, the method of the invention comprises a proposal of a number q less than p of relevant linear combinations of the p tests that comprise an arbitrarily large portion of the information present in the p tests.

Using Principal Component Analysis significantly reduces the number of work dimensions, while retaining a very significant portion of the information present in the initial point cluster, each point corresponding to a result of a test for an electronic component. The information extracted will be enough to characterize a structure of n electronic components and thus reveal the atypical electronic components.

According to a preferred embodiment, the q linear combinations of the p tests are chosen by establishing a Generalized Principal Component Analysis with a choice of metric M adapted to the p tests of n electronic components.

Here the use of a particular type of principal component analysis, called Generalized Principal Component Analysis, is chosen, whatever the metric used.

If, for example, the p tests have a common unit of measure, the Euclidean metric can be used, for example, and a Principal Component Analysis can be performed with this metric.

According to an advantageous embodiment, the metric M is chosen such that

M=W⁻¹ (inverse of the matrix W) where

$$W = \frac{{\sum }_{i = 1}^{n} exp ( \frac{- β}{2} {‖ {X}_{i} - {\overline{X}}_{n} ‖}_{{V}_{n}^{- 1}}^{2} ) {( {X}_{i} - {\overline{X}}_{n} )}^{t} ( {X}_{i} - {\overline{X}}_{n} )}{{\sum }_{i = 1}^{n} exp ( \frac{- β}{2} {‖ {X}_{i} - {\overline{X}}_{n} ‖}_{{V}_{n}^{- 1}}^{2} )}$$

$$square matrix of order p .$$

where
exp is the exponential function

and
Xᵢ column vector associated to an electronic component i from among the n electronic components, of dimension p corresponding to the p respective responses to each of the p tests on this electronic component i.

$${\overline{X}}_{n} = \frac{1}{n} {\sum }_{i = 1}^{n} {X}_{i}$$

vector of empirical means
^{t}(Xᵢ− X̅ₙ) is the transposed vector of (Xᵢ− X̅ₙ)
∥X∥_{V}_{ₙ}_{^{−1}}=^{t}XVₙ⁻¹X

$${V}_{n} = \frac{1}{n} {\sum }_{i = 1}^{n} {( {X}_{i} - {\overline{X}}_{n} )}^{t} ( {X}_{i} - {\overline{X}}_{n} ) ,$$

the matrix of the usual empirical variances and covariances Vₙ which is a square matrix of order p
Vₙ⁻¹ is the inverse matrix of the usual empirical variances and covariances Vₙ.
β is a small real number.

It is understood that the problem of centering the data is overcome by using such a metric, the set of vectors (Xᵢ− X̅ₙ) being by definition centered, and the problem of differences in measurement units or scales between the p tests is overcome by using the norm ∥X∥ᵥ_{ₙ}_{^{−1}}.

In a preferred embodiment, the principal vectors are chosen equal to the first q eigenvectors associated with the largest eigenvalues from the set of eigenvectors obtained by Principal Component Analysis, the number q being determined using a previously chosen criterion.

A criterion for automatically calculating the number of principal vectors q that will be used to evaluate each component is determined by the method.

Preferably, this criterion is such that the eigenvalue associated with a principal component is strictly greater than 1+β.

In a preferred embodiment, at least one projection is used on a vector sub-space generated by a sub-family of the principal vectors and at least one criterion for identifying the atypical electronic components.

More specifically in dimension 2, this or these vector sub-spaces are vector planes and the criterion for a vector plane, for identifying the atypical components, is achieved by considering the projection of the vectors Xᵢ on this vector plane, and by defining a circle of confidence of radius r encompassing a cluster, called the “majority” cluster, containing by definition the projection of the set of typical electronic components, and by declaring that an electronic component i is said to be atypical if the projection of Xᵢ on the vector plane is outside the circle of confidence.

Even more specifically, the radius r of the circle of confidence, for a level of significance α, is defined by the square root of the fractile of order 1−α of a χ² distribution to (2×\sqrt{1+β}) degrees of freedom.

For a vector Xᵢ, the norm of its projection on the vector plane defines a score. Electronic components are then ordered according to this score and eliminated if their score is greater than a previously calculated or chosen threshold.

According to a particular embodiment, the criterion for identifying the atypical electronic components uses the calculation of a score corresponding to its norm for each component, and a statistical limit for this score.

The invention also envisages software implementing the method as described.

### BRIEF DESCRIPTION OF THE FIGURES

The aims and advantages of the invention will be better understood in reading the following description, made with reference to the drawings in which:

FIG. 1 shows a projection of the vectors characterizing the electronic components and the respective responses to tests over a two-dimensional sub-space, generated by the system's first two principal components; in this figure, the atypical components far from the central point cluster, detected by the method according to the invention, are marked by stars,

FIG. 2 shows the incorporation of steps for eliminating atypical parts of the method of the invention, into the known method of checking components before delivery to a customer.

### DETAILED DESCRIPTION OF AN EMBODIMENT OF THE INVENTION

The invention is implemented by computer software running on a micro-computer or other standard type of computer.

The invention is intended to be used during the manufacturing quality control of electronic components:

1/ at the end of the probe tests that consist of several electronic measurements, which will be called the first series of tests, after rejecting the electronic components for which at least one response to at least one test forming part of this first test series is outside the specification limits linked to this test

2/ and then at the end of the tests performed (second series of tests) after the good electronic components, i.e. the electronic components that passed the probe tests and the test of the method of the invention, have been assembled in a casing.

The method according to the invention can be used either after the first series or after the two series of tests, regardless. In effect, it uses any number of tests performed on the electronic components considered.

The method according to the invention can also be used for testing electronic modules containing components: ABS, Airbag, smart card etc. modules.

The number n of electronic components in the current series to be studied and the number p of tests of the current series are noted.

It is considered that, among the n electronic components, the electronic components for which a response to at least one test is outside this test's specification limits have already been eliminated.

A data table is thus obtained, comprising n individuals (electronic components) and p variables (corresponding to each of the p tests of the current series) for each of the individuals. The values associated with these p variables are quantitative real numerical data. To each individual i (i ∈ [1, n]) an individual-vector Xᵢ (in a misuse of language, in the rest of the description this will be called individual Xᵢ) of dimension p is associated, having for coordinates on each axis i the response obtained to the test of index i.

The aim of the invention is to identify the atypical individuals among the set of individuals Xᵢ ∈ IR^{p}. To achieve this goal, techniques known as “informative projections” will be used. An informative projection is a projection of the cluster of individuals Xᵢ over a sub-space of dimension q (q<p) likely to highlight a potential specific structure of the distribution of these individuals.

In the case of electronic components, where p is a large number (typically several hundreds of tests are performed during an electronic component's inspection), it is useful to investigate whether q independent linear combinations (in the linear algebra sense) of the p variables can be defined that allow the study of the set of individuals Xᵢ (of dimension p) to be limited to a number q significantly smaller than p, without losing information present in the p initial variables, or losing information that can be estimated proportionally from the total information contained in the p variables.

A Generalized Principal Component Analysis (GPCA) is performed to identify these q independent linear combinations.

It is noted that a Principal Component Analysis (PCA) allows the overall structure of the cluster of individuals to be viewed and summarized in several dimensions (q) instead of viewed in dimension p.

Without going into details about this technique, known per se, it is noted that it consists of determining the axes of inertia of a cluster of points (the individuals) in a space of p dimensions (the variables); these axes (orthogonal by construction) are linear combinations of the initial axes, but, by definition, support a significant portion of the inertia of the clusters points (here the individuals), i.e. the information contained in these individuals.

There are as many axes of inertia as initial axes, but this principal component analysis allows the amount of information present on each of these axes to be known. The principal axes of inertia are obtained by sorting the axes of inertia according to the amount of information contained, and it is noted that usually only a few principal axes of inertia in fact contain a considerable portion of the total information for the individuals. Typically, a few dozen principal axes of inertia comprise more than 99.9% of the total information of several hundred initial axes.

Therefore, it is possible to limit the study of the individuals, which should be performed over p axes or dimensions (several hundred), to an arbitrary value of q dimensions, depending on the proportion of information one is prepared to not use.

The q independent linear combinations of the initial axes (the variables) will thus be the principal axes (principal components) derived from the Principal Component Analysis.

To refine the q principal components, instead of selecting a standard Principal Component Analysis, a Generalized Principal Component Analysis (GPCA) is chosen here, consisting of making a choice of metric (i.e. the calculation method for the distance between individuals, for the many distances that can be mathematically defined in the same space), optimized in the method according to the invention, in the specific case of electronic components.

It is recalled that in the standard Principal Component Analysis (PCA), the metric M used is either the Euclidean metric (M=Id) or the inverse variance metric M=D_{1/S}_{²} (diagonal matrix S=standard deviation).

The steps of the method according to the invention are as follows:
Step 1: Constituting n vectors Xᵢ of dimension p. This step is assumed to be known, the result files of the n electronic components in the p tests forming an input datum for the method. The vectors Xᵢ are stored in an ad hoc database.
Step 2: Using the chosen metric. The choice of the metric used in this method is especially important. In the preferred implementation, a metric M has been chosen that was inspired by the work of H Caussinus and Anne Ruiz-Gazen, and in particular inspired by an article published in the Journal of Applied Statistics, Volume 50 No. 4 (2002) p 81-94. This metric is suitable for highlighting atypical individuals insofar as it depends on the dispersion of data, each individual having less influence as it becomes more atypical. During a Principal Component Analysis, these atypical individuals will therefore have even more extreme coordinates that with a traditional PCA (Euclidean norm) for the different principal axes.
This metric is defined by:
   M=W⁻¹ (inverse of a matrix W) where W is defined by:

$$W = \frac{{\sum }_{i = 1}^{n} exp ( \frac{- β}{2} {‖ {X}_{i} - {\overline{X}}_{n} ‖}_{{V}_{n}^{- 1}}^{2} ) {( {X}_{i} - {\overline{X}}_{n} )}^{t} ( {X}_{i} - {\overline{X}}_{n} )}{{\sum }_{i = 1}^{n} exp ( \frac{- β}{2} {‖ {X}_{i} - {\overline{X}}_{n} ‖}_{{V}_{n}^{- 1}}^{2} )}$$

and is a square matrix of order p.
and:

$${\overline{X}}_{n} = \frac{1}{n} {\sum }_{i = 1}^{n} {X}_{i}$$

is the vector of empirical means of vectors Xᵢ,
^{t}(Xᵢ− X̅ₙ) is the transposed vector of (Xᵢ− X̅ₙ),
the norm used is defined by: ∥X∥_{V}_{ₙ}_{^{−1}}=^{t}XVₙ¹X,

$${V}_{n} = \frac{1}{n} {\sum }_{i = 1}^{n} {( {X}_{i} - {\overline{X}}_{n} )}^{t} ( {X}_{i} - {\overline{X}}_{n} ) ,$$

the matrix of the usual empirical variances and covariances Vₙ which is a square matrix of order p,
Vₙ⁻¹ is the inverse matrix of the usual empirical variances and covariances Vₙ.
exp is the exponential function.
In the formula defining the matrix W, a weight function K(x)=exp(−x/2) has therefore been introduced, which has been applied to x=β∥Xᵢ− X̅ₙ∥_{V}_{ₙ}_{¹}² with β, a small real datum (in fact very close to 0: a value of the order of 1/p is recommended, but an arbitrary choice can be made with a β of between 0.01 and 0.1—see the work by H. Caussinus and A. Ruiz-Gazen), for each vector Xᵢ. Using the weight function gives the following:

$$W = {S}_{n} ( β ) = \frac{{\sum }_{i = 1}^{n} K ( β {‖ {X}_{i} - {\overline{X}}_{n} ‖}_{{V}_{n}^{- 1}}^{2} ) {( {X}_{i} - {\overline{X}}_{n} )}^{t} ( {X}_{i} - {\overline{X}}_{n} )}{{\sum }_{i = 1}^{n} K ( β {‖ {X}_{i} - {\overline{X}}_{n} ‖}_{{V}_{n}^{- 1}}^{2} )}$$

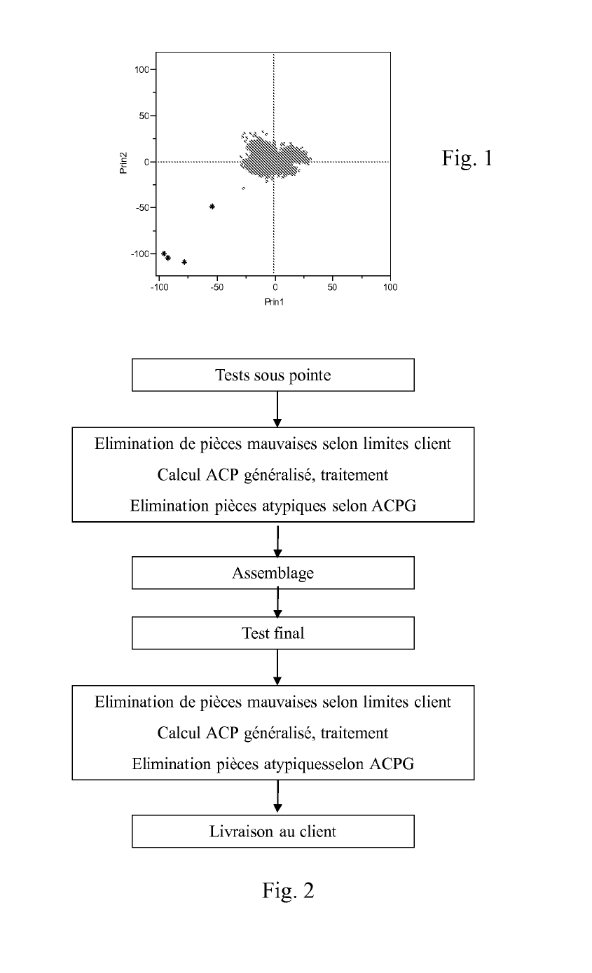

Step 3: Diagonalizing the matrix VₙM where Vₙ is the matrix of the values obtained above, and M is the metric used, also obtained in step 1 (methods of diagonalizing matrices are known to the expert, and possibly available as software libraries), searching for the eigenvalues of this matrix. This step is standard in a Principal Component Analysis.
Step 4: Calculating the useful dimension q of the projection space. It is noted that the dimension q determines the number of principal axes to which the analysis is reduced, and thus determines how much information is used from the set of information contained in the initial tests.
   This dimension q (the number of axes) must therefore be large enough to capture the structure sought (and therefore able to identify the atypical individuals, i.e. the electronic components likely to be defective) and small enough not to exhibit any artifacts (false identification of a chip as defective).
   It is noted that if the eigenvalues are ordered in descending order, the first eigenvectors (in this order) associated with these eigenvalues will be the system's principal vectors. In this step 4, a criterion is chosen that will make it possible to determine the number q of eigenvectors amongst the eigenvectors that will be sufficient to characterize the atypical individuals of our space of individuals and will therefore be the principal vectors of the system.
   The projection, obtained by projecting the individuals M-orthogonally on the sub-set of dimension q thanks to the choice of the metric M, is invariant through the affine transform of the vectors Xᵢ. This emphasizes the fact that it concerns only the structure of the cluster of individuals, beyond various aspects of balance and scale.
   The following choice criterion is used: the eigenvectors are kept where their associated eigenvalue is strictly greater than 1+β. If a model of atypical values is considered in which Xᵢ is assumed to be a random vector whose probability distribution is a mixture of q+1 normal distributions (in different proportions) of mean variables, the majority distribution, and q possibilities of contamination of the mean, then certain theoretical properties are verified and presented in what follows.
   For n fairly large, and small proportions associated to the q contaminations, the atypical values (i.e. the electronic components likely to be defective) are more apparent over the projection sub-spaces generated by the q means (associated to the contaminations).
   Moreover, for n large, the q largest eigenvalues of VₙM converge towards a number strictly greater than 1+β, and the next ones converge towards 1+β. By choice, in this non-limiting description of the method, the dimensions for which the eigenvalues are less than 1+β flare therefore not considered.
Step 5: Determining the dimension of representation. In order to simplify the representation of the cluster of points Xᵢ, performing the projections over vector planes, thus over two-dimensional spaces, is chosen. These vector planes are therefore generated by choosing two eigenvectors from the q eigenvectors chosen (which are the q principal vectors).
   The set of eigenvectors for a system form, in a known way, a free (independent) family in the linear algebra sense. The q vectors chosen from this set of eigenvectors thus form a sub-family of this free family in the linear algebra sense. Thus if, for example, q is equal to 6 and these six eigenvalues (principal vectors) are noted (Prin1, Prin2, Prin3, Prin4, Prin5, Prin6), the projections of the Xᵢ can be represented graphically over the three vector planes generated by (Prin1, Prin2), (Prin3, Prin4) and (Prin5, Prin6) respectively; the other combinations of these six vectors can also provide additional information. The vector planes to be used for any value of the number q of principal components chosen are determined similarly.
Step 6: Using the criterion for identifying atypical individuals. In each of the vector planes defined in step 5, it is chosen to define a circle of confidence. The detection of atypical components is then performed using this circle of confidence (for a fixed level of significance a) encompassing the majority cluster (2) and outside of which are located the individuals declared atypical.
   FIG. 1 thus illustrates a projection over two main axes (Prin1, Prin2). In this FIG. 1, two elements (1) are graphically distant from the majority cluster (2). In the example shown in FIG. 1, only the first two principal axes, i.e. those associated with the two largest eigenvalues (which therefore comprise the maximum of information), are retained.
   The distance between the points on these graphical representations here corresponds to an approximation of the Mahalanobis distance in the sense of the metric M. The radius of the circle of confidence corresponds to the square root of the quantile of order 1−α of a χ² distribution with (2×\sqrt{1+β}) degrees of freedom (this chi-square distribution operates under the assumption that the data follow a normal distribution and this circle is, to some extent, the equivalent of a confidence interval).
   The value of the level of significance a can be left to the choice of the user of the method of the invention; generally a varies between 1% and 5%.
   The atypical individuals identified at the end of the method are then listed in an ad hoc table for the operator.

It is noted that, for cost reduction reasons (cost of the assembly and the price of the casing), it is preferable to eliminate atypical electronic components before assembly in a casing, and it is therefore advantageous to initiate the method of the invention after the probe tests so as to try to detect a maximum of atypical electronic components during this production phase.

Benefits of the Invention

The benefit of the method described is to move from p continuous variables to q<p principal components, which are linear combinations of initial variables with the following interesting features:
Ordered according to the information returned: the first principal component is the linear combination of the initial variable having the maximum variance.
The principal components are non-correlated variables.
They are less sensitive to random fluctuations than the initial variables

Note that this is true only in the case of a Principal Component Analysis using the Euclidean metric (M=id). This is no longer true in the case of a Generalized Principal Component Analysis, using a different metric.

Variants of the Invention

The scope of this invention is not limited to the details of the forms of realization considered above as an example, but on the contrary extends to modifications in the reach of the expert.

In a variant, the metric

$$M = \frac{{W}^{- 1}}{1 + β}$$

is used. The eigenvalues to be considered for determining the principal components (eigenvectors associated with these eigenvalues) are thus, in this case, the eigenvalues strictly greater than 1.

In another variant, any metric M is used that is suitable for the types of measurements realized. For example, if the Euclidean metric is chosen, in the case of p measures with the same unit of measurement, the metric M can be equal to the identity matrix.

Similarly, a metric M equal to the inverse of the variances can be chosen when the units of measurement are not the same for all variables. In that case, in the Principal Component Analysis the correlation matrix is diagonalized.

An alternative way of identifying the atypical individuals is to calculate a score for each point, corresponding to its norm calculated with its q principal components selected, and to define a statistical limit by a usual method, known per se, (e.g. a limit control) for determining which individuals are out-of-distribution, and thus atypical, for this score (step 6).

The invention encompasses any general PCA method, in the sense of the diagonalization of a variance/covariance matrix estimator relative to another variance/covariance matrix estimator, the goal of which is to detect atypical observations.

In particular this includes the diagonalization of any VnM operator, where Vn is the usual empirical variance/covariance matrix and M is the inverse of any robust variance/covariance matrix estimator (e.g. an M-, S-, MM or tau estimator or the MCD minimum determinant estimator).

This also includes the diagonalization of an operator with the form UnM, where Un and the inverse of M are two robust estimators.

It is noted that the standard PCA and what is called the robust PCA are special cases of the generalized PCA, but their primary purpose is to detect the structure of the majority of the data, not potential atypical observations. The only atypical observations detected on the first principal axes of a usual or robust PCA are those that are atypical in the directions in which the dispersion of the majority of the data is maximum.

Thus, there is a fundamental difference between the standard or robust PCA and the method according to the invention; this lies in the choice of the dimension. The usual criteria of choice for all these methods are based on the eigenvalues of the diagonalized operators: only the principal components associated with the largest eigenvalues are retained.

But whereas the largest eigenvalues of a standard or robust PCA are associated with projection spaces where the dispersion of the majority of the data is maximum, the largest eigenvalues of the generalized PCA are associated with projection spaces that allow the best possible identification of the atypical individuals.

In the case where the size of the data (the number of variables) is large, the robust variance/covariance matrix estimator used in the generalized PCA method is not necessarily invertible. To solve this inversion problem, a Moore-Penrose pseudoinverse type of generalized inverse is used.

One just has to calculate the eigenvalues and eigenvectors of the matrix in order to obtain an inverse matrix. In the case of a variance/covariance matrix, these eigenvalues are positive real eigenvalues.

The inverse matrix is calculated by taking the inverse of the eigenvalues and keeping the same eigenvectors. If the variance/covariance matrix is not invertible (which occurs if the number of variables is large compared to the number of observations), it contains eigenvalues close to 0. Taking a generalized inverse consists of not inversing the eigenvalues close to 0 but taking them equal to 0 in the inverse matrix. This methodology is recommended when the covariance matrix is poorly conditioned (small eigenvalues), even if the inverse can be calculated numerically, to avoid too great an instability, which would result from large eigenvalues appearing in the inverse.

3) Other Informative Projection Methods

Other variants of the invention can be considered, including the methods described below. These methods have never been used in the semiconductor industry for the purpose of detecting atypical pieces in the context of the reliability of electronic chips (zero defect).

The generalized PCA, which is the subject of the description given above, is a particular method of informative projections (see Caussinus and Ruiz-Gazen, 2009). To solve the problem of a large number of dimensions relative to the number of observations, informative projection type of methods other than the generalized PCA are recommended.

The idea is to search for linear projections of data over one (possibly two) dimension that highlights atypical observations. The generalized PCA allows this goal to be achieved, but it may be supplemented by other methods of informative projections (“Projection Pursuit” in English) consisting of:

(i) defining a projection index that measures the interest of the projection in some way. In the case we are interested in here, the more a projection allows atypical observations to be revealed, the more interesting it is. In other words, the higher the projection index, the more the projection will highlight outliers,

(ii) searching for one or more projections that correspond to local maxima of the previously defined projection index. The implementation of this second step uses an optimization algorithm, which can be based on a deterministic method of finding local optima or a heuristic method in the case where the function index is not regular enough to use deterministic methods based on the gradient.

Projection indices suitable for finding atypical values are notably the Friedman index (1987), and also the kurtosis index (Pena and Prieto, 2001) and the Stahel-Donoho “outlyingness” measure (Stahel, 1981). The first two recommended indicators measure the interest of a projection in terms of distance from the normal distribution. It has been noted that the interesting projections obtained are primarily those which are far from the normal distribution in the tails of the distribution and thus are the projections likely to reveal atypical observations.

The Stahel-Donoho index measures an observation's deviation from the median as an absolute value, standardized by the median absolute deviation of the projected data. It can be generalized to any standardized measure of an observation's deviation from the center of the distribution.

For example, the median can be replaced by the mean and median absolute deviation by the standard deviation. In the latter case, this is the measure used as standard in the PAT (“Part Average Testing”) method mentioned at the beginning of the document.

It is noted that, unlike the PAT method which only applies over each of the initial variables, the method recommended in this variant aims to propose a PAT test over all linear combinations of the initial variables that best reveal atypical individuals. The latter method thus allows the multidimensional relationships that exist within the data to be taken into account, relationships that are absolutely not included in the usual PAT method.

As in the usual PAT method, one can decide to choose a threshold value, beyond which an individual is declared atypical, based on the maximum rejection threshold that one is prepared to tolerate (the rule known as the “3 sigma” rule, to be adapted according to the data and the maximum rejection percentage accepted).

It is also recommended to center the data and make them spherical before the index optimization step, since it has been noted on a practical level that this facilitates the discovery of interesting projections. One way to make data spherical is to calculate the usual principal components.

The invention also envisages any hybrid method using the generalized PCA in conjunction with the projection pursuit methods as recommended above.

Thus, the identification of atypical points, obtained through the maximization of a projection index, can be used to calculate a weighted variance/covariance matrix estimator (weights being assigned to individuals declared atypical in the previous step). The Stahel-Donoho estimator (Stahel, 1981) is thus defined from the Stahel-Donoho index. This estimator can then be used as a robust estimator in the generalized PCA.

1-10. (canceled)

11. Method for detecting atypical electronic components for the quality control of a set of n electronic components at the end of the manufacturing process, said components being subject to a number p of unit tests providing digital data, this set of n components consisting of electronic components whose response to each of the p unit tests is contained within pre-defined limits specific to each of the p tests,
characterized:
in that it uses the multidimensional information of the responses of dimension p of these n electronic components,
in that it comprises a proposal of a number q less than p of relevant linear combinations of the p tests that comprise an arbitrarily large portion of the information present in the p tests,
in that the q linear combinations of the p tests are chosen by establishing a Generalized Principal Component Analysis with a choice of metric M adapted to the p tests of n electronic components,
in that the method is implemented at the end of the probe tests and/or at the end of the tests performed after the good electronic components, i.e. the electronic components that passed the probe tests, have been assembled.

12. Method according to claim 11, characterized in that the metric M is chosen such that:
M=W⁻¹ (inverse of the matrix W) where
$$W = \frac{{\sum }_{i = 1}^{n} exp ( \frac{- β}{2} {‖ {X}_{i} - {\overline{X}}_{n} ‖}_{{V}_{n}^{- 1}}^{2} ) {( {X}_{i} - {\overline{X}}_{n} )}^{t} ( {X}_{i} - {\overline{X}}_{n} )}{{\sum }_{i = 1}^{n} exp ( \frac{- β}{2} {‖ {X}_{i} - {\overline{X}}_{n} ‖}_{{V}_{n}^{- 1}}^{2} )}$$
$$square matrix of order p ,$$
where
exp is the exponential function,
and
Xᵢ column vector associated to an electronic component i from among the n electronic components, of dimension p corresponding to the p respective responses to each of the p tests on this electronic component i,
$${\overline{X}}_{n} = \frac{1}{n} {\sum }_{i = 1}^{n} {X}_{i}$$
vector of empirical means,
^{t}(Xᵢ− X̅ₙ) is the transposed vector of (Xᵢ− X̅ₙ),
∥X∥_{V}_{ₙ}_{^{−1}}=^{t}XVₙ⁻¹X,
$${V}_{n} = \frac{1}{n} {\sum }_{i = 1}^{n} {( {X}_{i} - {\overline{X}}_{n} )}^{t} ( {X}_{i} - {\overline{X}}_{n} ) ,$$
the matrix of the usual empirical variances and covariances Vₙ which is a square matrix of order p,
Vₙ⁻¹ is the inverse matrix of the usual empirical variances and covariances Vₙ,
β is a small real number.

13. Method according to claim 12, characterized in that β is of the order of 1/p, or arbitrarily chosen between 0.01 and 0.1.

14. Method according to claim 13, characterized in that the principal vectors are chosen equal to the first q principal vectors associated with the largest eigenvalues from the set of principal vectors obtained by principal component analysis, the number q being determined using an optimized criterion.

15. Method according to claim 14, characterized in that the criterion is such that the eigenvalue associated with a principal component is strictly greater than 1+β.

16. Method according to claim 14, characterized in that it uses at least one projection on a vector sub-space generated by a sub-family of the principal components and at least one criterion for identifying the atypical electronic components.

17. Method according to claim 16, characterized in that:
this or these vector sub-spaces are vector planes,
the criterion for identifying the atypical components is checked by considering the projection of the vectors Xᵢ on each vector plane, and by defining a circle of confidence of radius r encompassing a cluster, called the “majority” cluster, containing by definition the projection of the set of typical electronic components, and by declaring that an electronic component i is said to be atypical if the projection of Xᵢ on the vector plane is outside the circle of confidence.

18. Method according to claim 17, characterized in that the radius r of the circle of confidence, for a level of significance α, is defined by the square root of the fractile of order 1−α of a χ² distribution to (2×\sqrt{1+β}) degrees of freedom.

19. Method according to claim 16, characterized in that, the criterion for identifying the atypical electronic components uses the calculation of a score corresponding to its norm for each component, and a statistical limit for this score.

20. Method according to claim 11, characterized in that it comprises, in addition, steps in which:
linear projections of data are sought over one or two dimensions that highlight the atypical observations,
a projection index is defined that measures the interest of the projection; the higher the projection index, the more the projection will highlight outliers,
one or more projections are sought that correspond to local maxima of the projection index.
